(19) United States
(12) Patent Application Publication
(10) Pub. No.: US 2008/0162295 A1
(43) Pub. Date: Jul. 3, 2008

(54) METHOD AND SYSTEM FOR PAYMENT AUTHENTICATION

(75) Inventor: Osama Mostafa Bedier, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/618,104

(22) Filed: Dec. 29, 2006

(51) Int. Cl. G06Q 20/00

(52) U.S. Cl. 705/26; 705/44

(57) ABSTRACT

Embodiments for a method and system for payment authentication are disclosed. An electronic payment data structure may include one or more electronic payment fields. Each electronic payment field may provide access to an account value from a payment source selected from at least one payment source. A payment transaction data structure may comprise a matching selection associated with a seller criterion. The matching selection may be comparable against verifying data. The seller criterion may define a circumstance in which a payment request from a seller is to be fulfilled. A payment application may fulfill the payment request to the seller when the matching selection matches the verifying data and the circumstance defined by the seller criterion is met.

### TECHNICAL FIELD

The present application relates generally to the field of electronic payments and, in one specific example, to a method and system for authenticating payments from a buyer to a seller.

### BACKGROUND

Buyers may make electronic payments online from a user account of a payment source to a seller. To make a payment request, a buyer may login in with a user name and password to the payment source through a server of the seller. The user name and password of the buyer may be accessible by both the seller and the payment source.

### BRIEF DESCRIPTION OF THE DRAWINGS

Some embodiments are illustrated by way of example and not limitation in the figures of the accompanying drawings in which:

FIG. 1 is a network diagram depicting a network system, according to one embodiment, having a client server architecture configured for exchanging data over a network;

FIG. 2 is a block diagram illustrating an example embodiment of multiple network and marketplace applications, which are provided as part of the network-based marketplace;

FIG. 3 is a high-level entity-relationship diagram, in accordance with one example embodiment, illustrating various tables that may be maintained within one or more databases;

FIG. 4 is a block diagram of a network system for exchanging data over a network according to an example embodiment;

FIG. 5 is a block diagram of an example user account data structure;

FIG. 6 is a block diagram of an example personal/business information data structure;

FIG. 7 is a block diagram of an example electronic payment data structure;

FIG. 8 is a block diagram of an example payment transaction data structure;

FIG. 9 is a flowchart illustrating a method for utilizing a user account for a payment according to an example embodiment;

FIG. 10 is a flowchart illustrating a method for accessing a user account according to an example embodiment;

FIG. 11 is a flowchart illustrating a method for modifying the payment transaction data structures according to an example embodiment;

FIG. 12 is a flowchart illustrating a method for processing a received matching selection according to an example embodiment;

FIG. 13 is a flowchart illustrating a method for associating one or more seller selection criterion with a matching selection according to an example embodiment;

FIG. 14 is a flowchart illustrating a method for modifying the payment source selections field according to an example embodiment;

FIG. 15 is a flowchart illustrating a method for processing an order from the buyer machine according to an example embodiment;

FIG. 16 is a flowchart illustrating a method for processing an electronic payment according to an example embodiment;

FIG. 17 is a flowchart illustrating a method for processing an electronic payment according to an example embodiment;

FIG. 18 is a flowchart illustrating a method for processing a payment amount according to an example embodiment; and

FIG. 19 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for collaborative and private shopping are described. In the following description, for purposes of explanation, numerous specific details are set forth in order to provide a thorough understanding of example embodiments. It will be evident, however, to one skilled in the art that the present invention may be practiced without these specific detail

In an example embodiment, an electronic payment data structure may include one or more electronic payment fields. Each electronic payment field may provide access to an account value from a payment source identified from among one or more payment sources. A payment transaction data structure may comprise a matching selection associated with a seller criterion. The matching selection may be comparable against verifying data. The seller criterion may define a circumstance in which a payment request from a seller is to be fulfilled. A payment application may fulfill the payment request to the seller when the matching selection matches the verifying data and the circumstance defined by the seller criterion is met.

In an example embodiment, a matching selection may be accessed. The matching selection to be compared against verifying data. At least one seller criterion may be associated with the matching selection. Each of the at least one seller criterion may define a circumstance in which a payment request from a seller is to be fulfilled when the matching selection matches the verifying data. the association of the at least one seller criterion may be made with the matching selection available to a payment application. The payment application may be capable of using the association to determine whether to fulfill the payment request.

In an example embodiment, an account identifier and verifying data may be accessed. The account identifier may identify a user account. One or more payment source selections associated with the user account may be accessed. A payment amount may be processed from the one or more payment source selections when the verifying data matches a matching value and a seller criterion associated with the matching value is met.

In an example embodiment, an account identifier of a buyer, verifying data, and a payment amount may be provided to an application server. The payment amount may include an amount of value to be transferred from the buyer to a seller. The account identifier may be used by the application server to identify a matching selection and an associated seller criterion defined by the buyer. A positive response may be received from the application server indicating that the payment amount has posted to an account of the seller when the verifying data matches the matching selection and the seller criterion is satisfied.

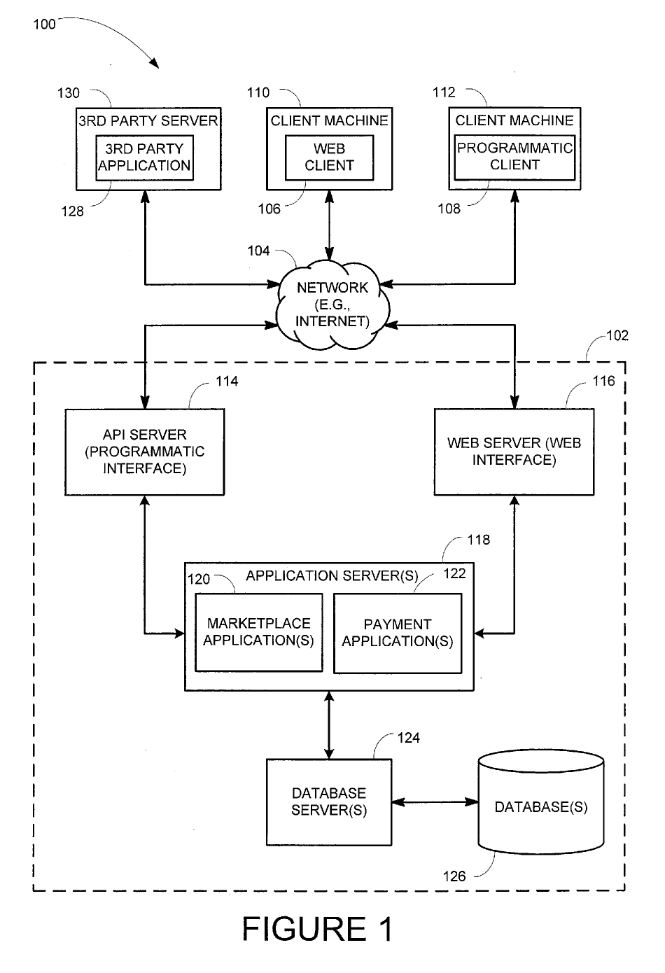

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Washington State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

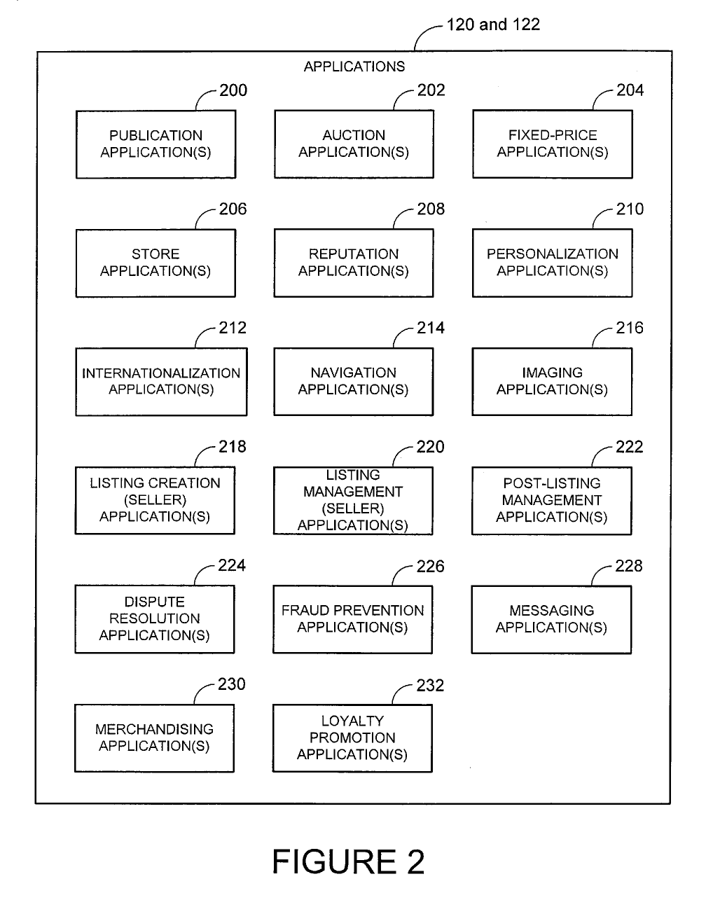

FIG. 2 is a block diagram illustrating multiple applications 120 and 122 that, in one example embodiment, are provided as part of the networked system 102 (see FIG. 1). The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized and/or localized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or system inventory structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one have a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and be offered a reward for which accumulated loyalty points can be redeemed.

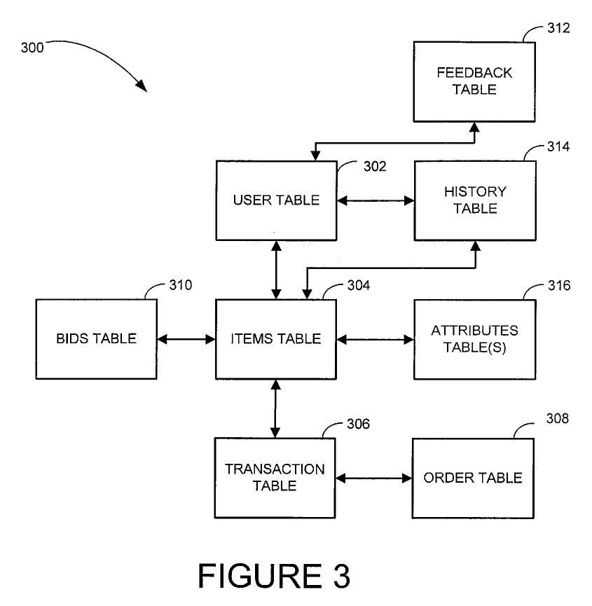

FIG. 3 is a high-level entity-relationship diagram, illustrating various tables 300 that may be maintained within the databases 126, and that are utilized by and support the applications 120 and 122 (see FIG. 1). A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items (e.g., products and/or services) that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order for a good and/or service. Each order, in turn, may be with respect to one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users.

A history table 314 maintains a history of transactions to which a user has been a party. The transactions may include those pertaining to items for which records exist within the items table 304 and for items with which no records exist within the items table 304 (e.g., for which payment services and functions of the payment application 122 were used without the marketplace application 120).

One or more attribute tables 316 record attribute information pertaining to items for which records exist within the items table 304. Considering only a single example of such an attribute, the attribute tables 316 may indicate a currency attribute associated with a particular item, the currency attribute identifying the currency of a price for the relevant item as specified in by a seller.

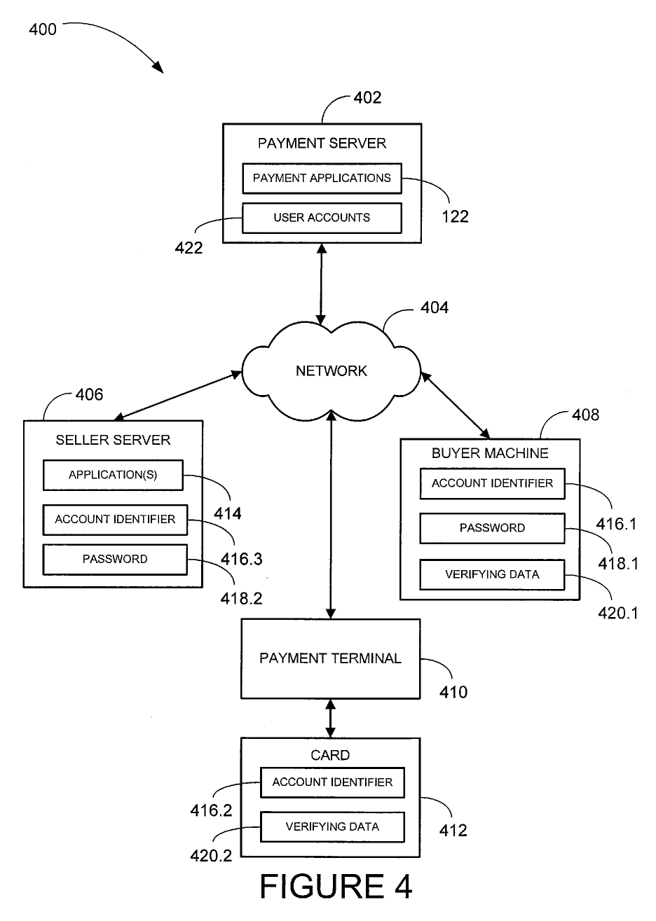

Referring to FIG. 4, a network system 400 according to an example embodiment is illustrated. The network system 400 may include a payment server 402 to communicate over a network 404 with a seller server 406. The network 404 may include the functionality of the network 104 (see FIG. 1).

The payment server 402 may include the payment applications 122 (see FIG. 1) and a plurality of user accounts 422. The plurality of user accounts 422 may contain an account for each user of the payment applications 122 to enable the user to make a payment and/or receive a payment. In an example embodiment, the plurality of user accounts 422 may be stored on a database (e.g., the database 126 of FIG. 1) and accessible to the payment applications 122.

The seller server 406 may include a number of applications 414. For example, the applications 414 may include the functionality of the marketplace applications 120 and/or the third party application 128 (see FIG. 1). The seller server 406 may include an account identifier 416.3 and a password 418.2 to access a user account associated with the seller from among the plurality of user accounts 422.

The network system 400 further includes a buyer machine 408 and/or a payment terminal 410. The buyer machine 408 may include the functionality of the client machine 110, the client machine 112, and/or the third party server 130 (see FIG. 1).

The buyer machine 408 may receive an account identifier 416.1, a password 418, and/or a verifying data 420.1 from a buyer. The account identifier 416.1 identifies an account of a user (e.g., a buyer) from among the plurality of user accounts 422. For example, the account identifier 416.1 may be an e-mail address, an account id (e.g., a user name or user code), a pin number, or the like.

The password 418.1 may be provided along with the account identifier 416.1 to the payment server 402 to enable the user to interface with the payment applications 122. For example, a user (e.g., a buyer or a seller) may provide the account identifier 416 and the password 418 to access to the associated user account on the payment server 402 for purposes such as to make a payment, receive a payment, modify settings of the user account, transfer a requested value from a first payment source to a second payment source, and the like.

The verifying data 420.1 is a value that may be provided over the network 404 to verify an identity of the user associated with the account identifier 416 to facilitate making a payment. By way of example, the account identifier 416 and the verifying data 420 may be provided by a buyer (e.g., through the buyer machine 408 or the payment terminal 410) to the seller server 406. The seller server 406 may provide the account identifier 416 and the verifying data 420 to the payment server 402 to receive payment (e.g., a transfer of the requested value from the buyer to the seller).

It should be appreciated that providing a seller with the verifying data 420 instead of the password 418 may enable more than way to authenticate a user. For example, the access provided when authorizing the verifying data 420 may be more limited than with the password 418, such as to prevent a seller from obtaining unauthorized access to a user account of the buyer. The use of two different authorization mechanisms using the verifying data 420 differing from the password 418 may also limit the buyer's exposure to risk.

A card 412 may provide an account identifier 416.2 and a verifying data 420.2 to the payment terminal 410. The payment terminal 410 may provide the account identifier 416.2 and the verifying data 420.2 to the seller server 406 or directly to the payment server 402.

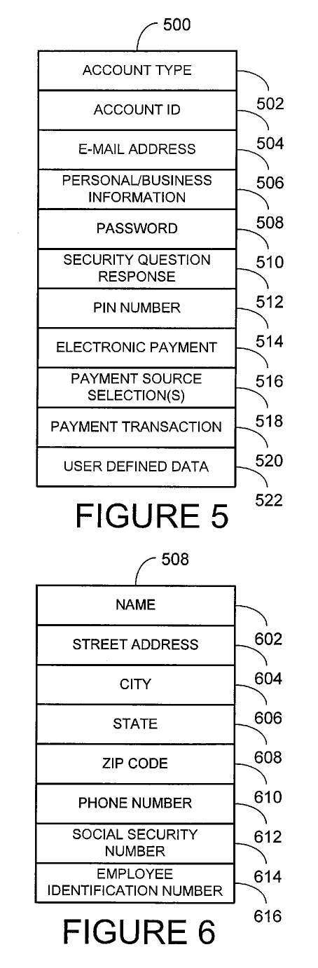

Referring to FIG. 5, an example user account data structure 500 is illustrated. In an example embodiment, a user account data structures 500 may be associated with each user of the plurality of user accounts 422 (see FIG. 4).

The user account data structure 500 may include an account type field 502, an account ID field 504, one or more e-mail address fields 506, one or more personal/business information data structures 508, a password field 510, one or more security question response fields 512, a pin number field 514, one or more electronic payment data structure 516, a payment source selections field 518, one or more payment transaction data structures 520, and/or one or more user defined data fields 522.

The account type field 502 provides (e.g., by retaining) an account identifier to identify whether the user account is associated with a person or a business. The account id field 504 provides (e.g., by retaining) an account id to enable identification of the user account from among the plurality of user accounts 422. The one or more e-mail address fields 506 provides (e.g., by retaining) one or more e-mail addresses (e.g., a primary and/or an alternate e-mail address) for the user.

The one or more personal/business information data structures 508 may each include a number of personal/business information fields to provides (e.g., by retaining) a mailing address, a telephone number, and the like. An example embodiment of the personal/business information data structure 508 is described in greater detail below.

The one or more security question response fields 512 may each provide (e.g., by retaining) a responses to a security question and may optionally identify the security question to which the response is directed. For example, the security questions may be questions posed to a user by the payment applications 122 such as “What is your mother's maiden name?”, “Where were you born?”, “What was the name of your first pet?”, and the like.

The pin number field 514 may provides (e.g., by retaining) a pin number (e.g., a four digit pin or a six digit pin) for the user account. For example, the pin number may be a code used by a user to facilitate payments using a mobile device (e.g., by SMS or a phone call).

The electronic payment data structure 516 may include a number (e.g., one or a plurality) of electronic payment fields that each provides access to an account value (e.g., an accumulated value or an owed value) from a payment source (e.g., a user account, a bank account, or a credit card account) identified from among one or more payment sources. In an example embodiment, the account value may indicate a funds availability of a payment source. An example embodiment of the electronic payment data structure 516 is described in greater detail below.

The payment source selections field 518 may provide (e.g., by retaining) an identification of one or more payment sources to be used for a payment request and optionally a priority by which the one or more payment sources are to be used when attempting to fulfill the payment request. For example, the priority may be used to determine from which credit card account among a number of credit card accounts a requested value should first be taken (or attempted to be taken).

One or more payment transaction data structures 520 may be used to evaluate whether a payment should be provided from a buyer to a seller based on the account identifier 416 and verifying data 420 received. An example embodiment of the payment transaction data structure 520 is described in greater detail below.

The user defined data fields 522 may each provide (e.g., by retaining) user defined data provided by a user.

Referring to FIG. 6, an example personal/business information data structure 508 is illustrated. In an example embodiment, the personal/business information data structure 508 may include a name field 602, a street address field 604, a city field 606, a state field 608, a zip code field 610, a phone number field 612, a social security number field 614, and/or an employee identification number field 616.

The name field 602 may provide (e.g., by retaining) a name of the user associated with the user account, a street address field 604 may provide a street of a mailing address of the user, a city field 606 may provide a city of the mailing address of the user, a state field 608 may provide a state of the mailing address of the user, a zip code field 610 may provide a zip code of the mailing address of the user, a phone number field 612 may provide a phone number of the user, a social security number field 614 may provide a social security number of the user, and/or an employee identification number field 616 may provide an employee identification (e.g., a federal tax identification) of the user.

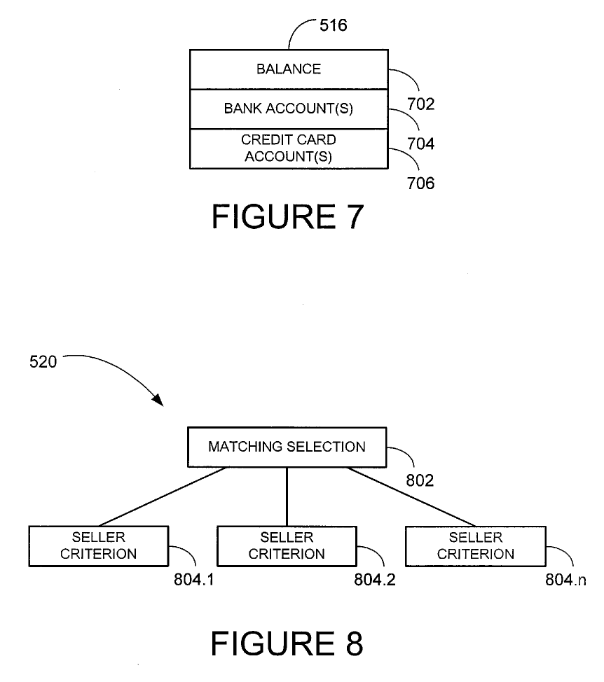

Referring to FIG. 7, the electronic payment data structure 516 (see FIG. 5) is illustrated. In an example embodiment, the electronic payment data structure 516 may include a balance field 702, one or more bank account fields 704, and/or one or more credit card account fields 706.

The balance field 702 provides access to a balance of a value (e.g., a value balance) of a user associated with a user account. For example, the value balance may indicate an amount of money that the user owes or that the user has within the user account. The bank accounts field 704 provides access to the value in a bank account. The credit card account field 706 provides access to the value from a credit card account (e.g., as may be borrowed from the credit card account).

It may be appreciated that other types of payment sources (e.g., beyond a balance, a bank account, or a credit card account) may be used and that an additional electronic payment field may access the value associated with the additional payment source.

Referring to FIG. 8, an example payment transaction data structure 520 (see FIG. 5) is illustrated. The payment transaction data structure 520 may include a matching selection 802 associated with one or more seller criterion 804.1-804.n.

The matching selection 802 may be data selected from the user account data structure 500 (see FIG. 5) to be compared against the verifying data 420 as described in greater detail below. For example, the matching selection 802 may be a number of digits (e.g., the last four digits) of a credit card account stored in the credit card account field 706 (see FIG. 7), the zip code stored in the zip code field 610 (see FIG. 6), an alternate e-mail address retained in the e-mail address field 506, a security question response retained in the security question response field 512, user defined data (e.g., a special password) retained in the user defined data field 522, and the like.

The seller criterion 804 defines a circumstance in which a payment request from a seller is to be fulfilled. For example, the seller criterion 804 may be that the payment request is within a defined range (e.g., greater than five hundred dollars, less than twenty dollars), that the buyer has previously made a purchase from the seller, the items purchased are a certain type of item, and the like.

By way of an example, the seller criterion 804 may be used to define a transaction amount for a series of transactions by selecting a unique matching selection 802 where the seller criterion 804 is a total amount for the transaction.

In an example embodiment, multiple different matching selections 802 may be used to authenticate a payment for a particular seller when the seller criterion 804 is met for each of the multiple different matching selections 802.

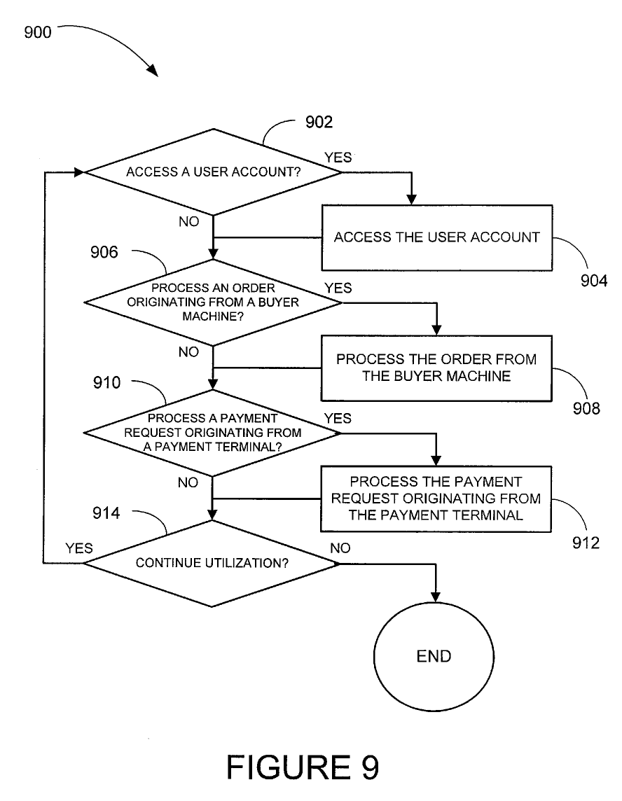

Referring to FIG. 9, a method 900 for utilizing a user account for a payment according to an example embodiment is illustrated. In an example embodiment, the method 900 may be performed by the payment server 402 (see FIG. 4).

A determination may be made at decision block 902 whether to access a user account. If a determination is made to access the user account, the user account may be accessed at block 904. An example embodiment of accessing the user account is described in greater detail below. If a determination is made not to access the user account at decision block 902 or upon completion of the operations at block 904, the method 900 may proceed to decision block 906.

At decision block 906, a determination may be made whether to process an order for the user account originating from the buyer machine 408 (see FIG. 4). If a determination is made to process the order originating from the buyer machine 408, the order may be processed at block 908. An example embodiment of processing the order originating from the buyer machine is described in greater detail below. If a determination is made not to process the order originating from the buyer machine 408 at decision block 906 or upon completion of the operations at block 908, the method 900 may proceed to decision block 910.

A determination may be made at decision block 910 whether to process a payment request from a user account originating from the payment terminal 410 (see FIG. 4). If a determination is made to process the payment request originating from the payment terminal 410, the payment request may be processed at block 912. An example embodiment of processing the payment request is described in greater detail below. If a determination is made not to process the payment request originating from the payment terminal 410 or upon completion of the operations at block 912, the method 900 may proceed to decision block 914.

At decision block 914, a determination may be made whether to continue utilizing the user account. If a determination is made to continue utilization, the method 900 may return to decision block 902. If a determination is made not to continue processing at decision block 914, the method 900 may terminate.

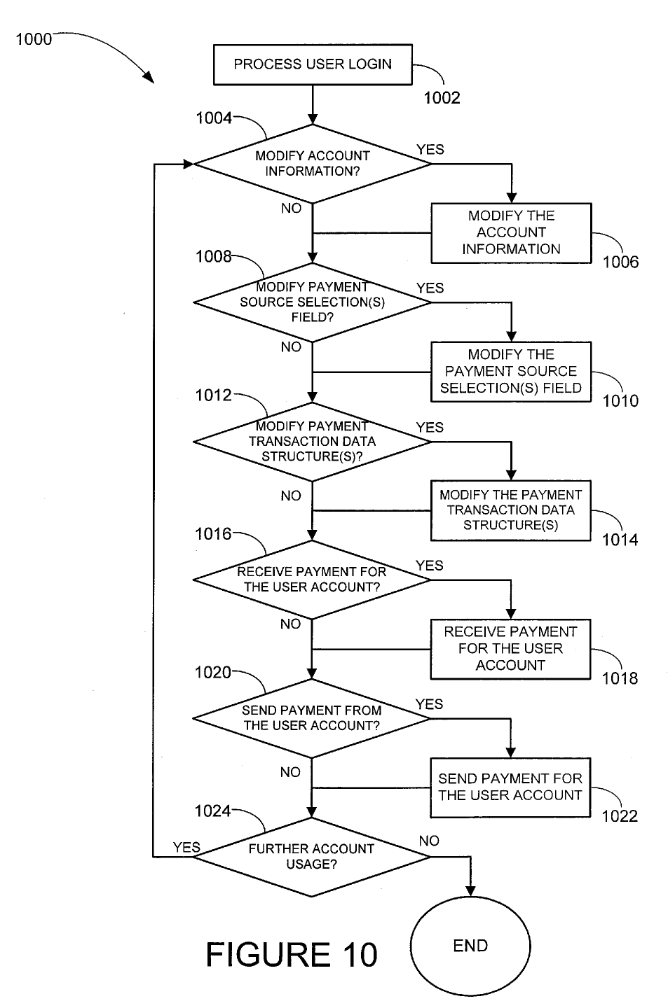

Referring to FIG. 10, a method 1000 for accessing a user account according to an example embodiment is illustrated. In an example embodiment, the method 1000 may be performed at block 904 (see FIG. 9).

A user login may be processed at block 1002. For example, the account identifier 416 and the password 418 (see FIG. 4) may be received and processed by the payment server 402 at block 1002.

A determination may be made at decision block 1004 whether to modify account information. For example, the account information may include data retained in the e-mail address fields 506, the personal/business information field 508, the password field 510, the security question response fields 512, the pin number field 514, the electronic payment field of the electronic payment data structure 516, and/or the user defined data field 522 (see FIG. 5). If a determination is made to modify the account information, the account information may be modified at block 1006. If a determination is made not to modify the account information at decision block 1004 or upon completion of the operations at block 1006, the method 1000 may proceed to decision block 1008.

At decision block 1008, a determination may be made whether to modify the payment source selections field 518 (see FIG. 5). If a determination is made to modify the payment source selections field 518, payment source selections field 518 may be modified at block 1010. An example embodiment of modifying payment source selections field 518 is described in greater detail below. If a determination is made not to modify the payment source selections field 518 at decision block 1008 or upon completion of the operations at block 1010, the method 1000 may proceed to decision block 1012.

A determination may be made at decision block 1012 whether to modify one or more of the payment transaction data structures 520 (see FIG. 5). If a determination is made to modify the payment transaction data structures 520, the payment transaction data structures 520 may be modified at block 1014. For example, a new payment transaction data structure 520 may be added, an existing payment transaction data structure 520 may be deleted, or a seller criterion 804 may be added or deleted at block 1014. An example embodiment of modifying the payment transaction data structures 520 is described in greater detail below. If a determination is made not to modify the payment transaction data structures 520 at decision block 1012 or upon completion of the operations at 1014, the method 1000 may proceed to decision block 1016.

A determination may be made at decision block 1016 whether to receive a payment for the user account. If a determination is made to receive the payment for the user account, the payment may be received for the user account at block 1018. For example, the received payment may increase the account value accessed by the electronic payment field of the electronic payment data structure 516. If a determination is made not to receive the payment for the user account at decision block 1016 or upon completion of the operations at block 1018, the method 1000 may proceed to decision block 1020.

At decision block 1020, a determination may be made whether to send a payment from the user account. If a determination is made to send payment from the user account, the payment may be sent from the user account at block 1022. For example, the sent payment once received and processed may decrease the account value accessed by the electronic payment field 516. If a determination is made not to send the payment from the user account at decision block 1020 or upon completion of the operations at block 1022, the method 1000 may proceed to decision block 1024.

A determination may be made at decision block 1024 whether to further use the user account. If a determination is made to further use the user account, the method 1000 may return to decision block 1004. If a determination is made not to further use the user account at decision block 1024, the method 1000 may terminate.

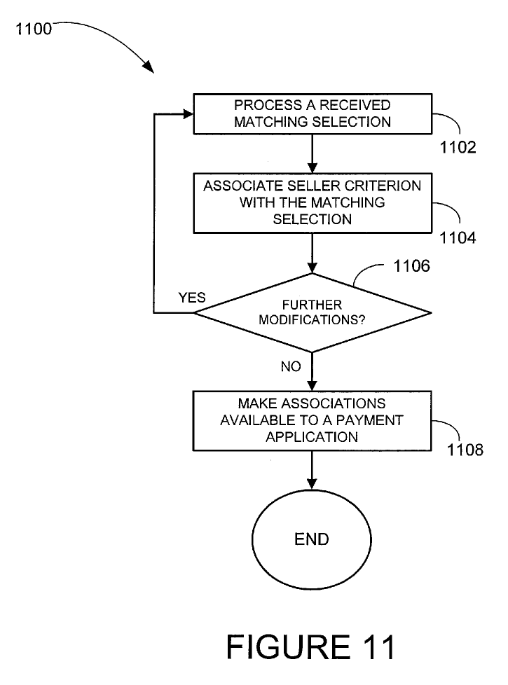

Referring to FIG. 11, the method 1100 for modifying the payment transaction data structures 520 (see FIG. 5) according to an example embodiment is illustrated. In an example embodiment, the method 1100 may be performed at the block 1014 (see FIG. 10).

A matching selection 802 (see FIG. 8) may be processed at block 1102. For example, the matching selection 802 may be processed by the payment applications 122 (see FIG. 4). An example embodiment of a method of processing the matching selection 802 is described in greater detail below.

One or more seller criterion 804 (see FIG. 8) may be associated with the matching selection 802 at block 1104. An example embodiment of associating one or more seller criterion 804 with the matching selection 802 is described in greater detail below.

A determination may be made at decision block 1106 whether to make further modifications. If a determination is made to make further modifications, the method 1100 may return to block 1102. If a determination is made at decision block 1106 not to make further modifications, the association (e.g., of the at least one seller criterion with the matching selection in the form of one or more payment transaction data structures 520) may be made available to the payment application 122 at block 1108. For example, the payment application 122 may use the association to determine whether to fulfill a payment request. Upon completion of the operations at block 1108, the method 1100 may terminate.

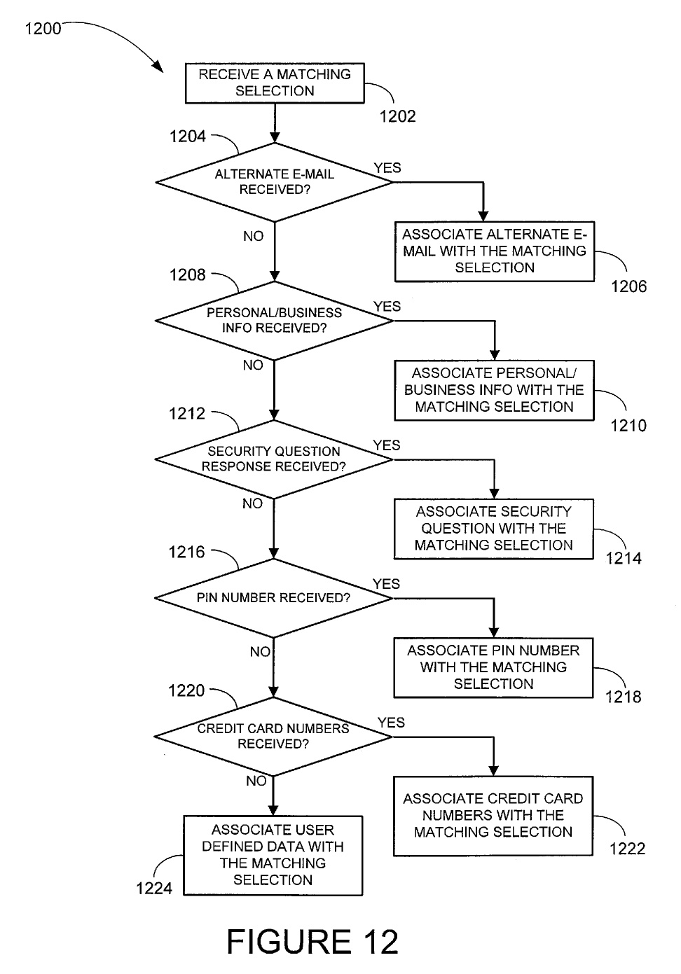

Referring to FIG. 12, a method 1200 for processing the received matching selection 802 (see FIG. 8) according to an example embodiment is illustrated. In an example embodiment, the method 1200 may be performed at block 1102.

A matching selection 802 may be received at block 1202. For example, the matching selection 802 received may for an existing matching selection 802 of an existing payment transaction data structure 520 for a new matching selection 802 for a new payment transaction data structure 520.

A determination may be made at decision block 1204 whether an alternate e-mail has been received. If an alternate e-mail selection has been received, the alternate e-mail may be associated with the matching selection 802 at block 1206. For example, an existing matching selection 802 of an existing payment transaction data structure 520 may be accessed at block 1206 or a new matching selection 802 may be created for a new payment transaction data structure 520 at block 1206. If the alternate email selection has not been received at decision block 1204, the method 1200 may proceed to decision block 1208.

At decision block 1208, a determination may be made as to whether a personal/business information has been received. If the personal/business information has been received, the personal/business information may be associated with the matching selection 802 at block 1210. If a determination is made that the personal/business information has not been received, the method 1200 may proceed to decision block 1212.

A determination may be made at decision block 1212 as to whether the security question response has been received. If the security question response has been received, the security question response may be associated with the matching selection 802 at block 1214. If a determination is made that the security question response has not been received, the method 1200 may proceed to decision block 1216.

A determination may be made at decision block 1216 whether a pin number has been received. If the pin number selection has been received, the pin number may be associated with the matching selection 802 at block 1218. If a determination is made that the pin number has not been received, the method 1200 may proceed to decision block 1220.

At decision block 1220, a determination may be made as to credit card number have been received. If the credit card numbers have been received, the credit numbers may be associated with the matching selection 802 at block 1222. If a determination is made that the credit card numbers have not been received at decision block 1220, a user defined data may be associated with the matching selection 802 at block 1224.

Upon completion of the operations at block 1206, block 1210, block 1214, block 1218, block 1222, or block 1224, the method 1200 may terminate.

It should be appreciated that other data received from a user that may be retained in a field of the user account data structure 500 may also be associated with the matching selection during operations of the method 1200.

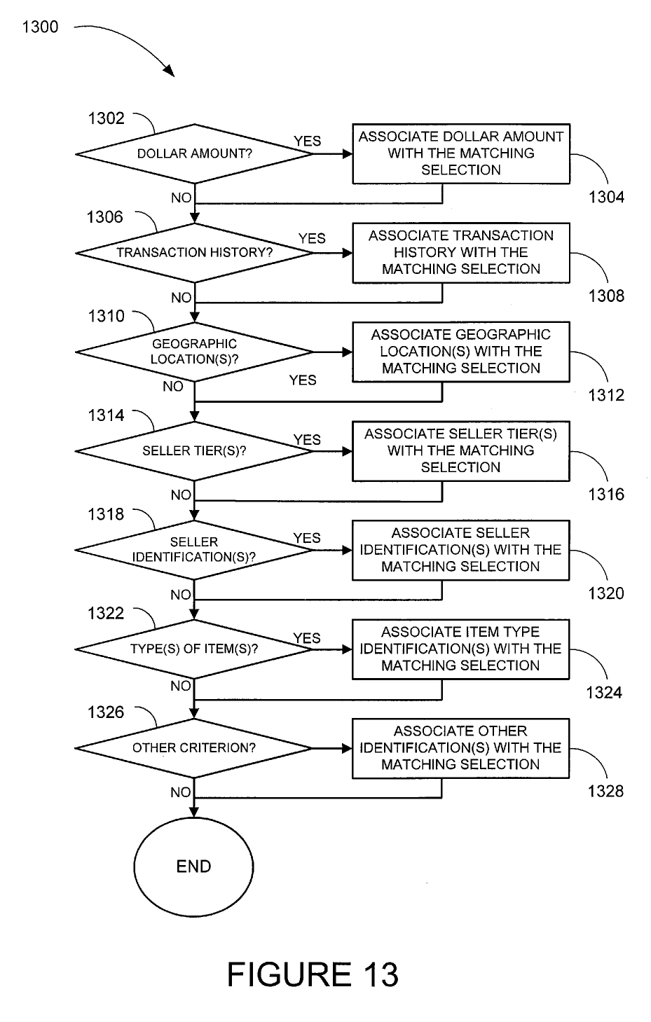

Referring to FIG. 13, a method 1300 for associating one or more seller criterion 804 with the matching selection 802 according to an example embodiment is illustrated. In an example embodiment, the method 1300 may be performed at block 1104 (see FIG. 11).

A determination may be made at decision block 1302 whether to associate a dollar amount with the matching selection 802. If a dollar amount has been selected for association, the dollar amount may be associated (e.g., as a seller criterion 804) with the matching selection 802 at block 1304. If a dollar amount has not been selected at decision block 1302 or upon completion of the operations at block 1304, the method 1300 may proceed to decision block 1306.

At decision block 1306, a determination may be made as to whether to associate a transaction history (e.g. a previous transaction with a seller) with the matching selection 802. If the transaction history has been selected for association, the transaction history may be associated (e.g., as a seller criterion 804) with the matching selection 802 at block 1308. If the transaction history has not been selected at decision block 1306 or upon completion of the operations at block 1308, the method 1300 may proceed to decision block 1310.

A determination may be made at decision block 1310 whether to associate a geographic location with the matching selection 802. If the geographic location has been selected for association, the geographic location may be associated (e.g., as a seller criterion 804) with the matching selection 802 at block 1312. If the geographic location has not been selected at decision block 1310 or upon completion of the operations at block 1312, the method 1300 may proceed to decision block 1314.

A determination may be made at decision block 1314 whether to associate a seller tier with the matching location. For example, the seller tier (e.g., a grouped ranking of sellers) may be defined by the user or accessed from a third party source. If the seller tier has been selected for association, the seller tier may be associated (e.g., as the seller criterion 804) with the matching selection 802 at block 1316. If the seller tier has not been selected at decision block 1314 or upon completion of the operations at block 1316, the method 1300 may proceed to decision block 1318.

A determination may be made at decision block 1318 whether to associate one or more seller identifications (e.g., identification of a seller or a class of sellers) with the matching selection 802. If the seller identification has been selected for association, the seller identification may be associated (e.g., as the seller criterion 804) with the matching selection 802 at block 1320. If the merchant identifications have not been selected at decision block 1318 or upon completion of the operations at block 1320, the method 1300 may proceed to decision block 1322.

At decision block 1322, a determination may be made whether to associate one or more types of items with the matching selection 802. If an item type has been selected for association, the item type may be associated (e.g., as the seller criterion 804) with the matching selection 802 at block 1324. If the item type has not been selected at decision block 1322 or upon completion of the operations at block 1324, the method 1300 may proceed to decision block 1326.

A determination may be made at decision block 1326 as to whether to associate one or more other criterion with the matching selection 802 at decision block 1326. If the one or more other criterion has been selected for association, the other criterion may be associated (e.g., as the seller criterion 804) with the matching selection 802 at block 1328. If the one or more other criterion has not been selected at decision block 1326 or upon completion of the operations at block 1328, method 1300 may terminate.

It should be appreciated that the seller criterion 804 associated with the matching selection 802 may be individually associated with the matching selection or jointly with other seller criterion 804. For example, the matching selection for the last five digits of a credit card may be “one hundred dollars or less” (e.g., a single seller criterion 804), or may be a seller with which the buyer has previously had a transaction and the seller is located in the state of California (e.g., a seller criteria 804)

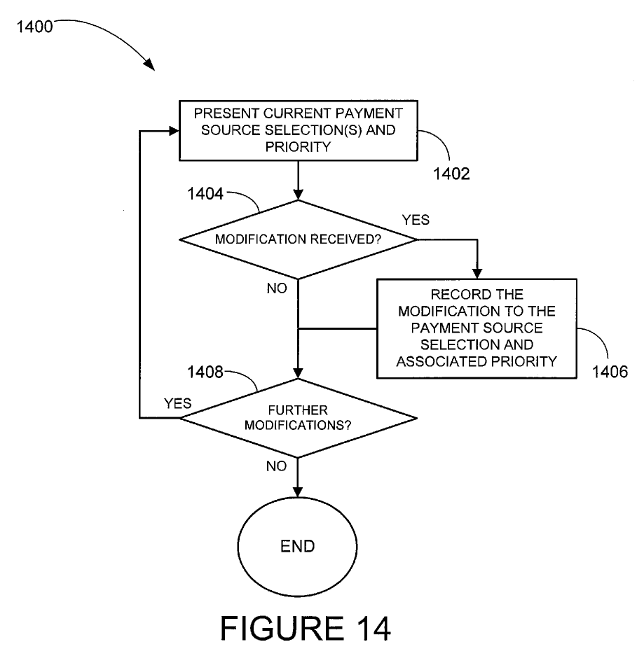

Referring to FIG. 14, a method 1400 for modifying the payment source selections field 518 (see FIG. 5) according to an example embodiment is illustrated. In an example embodiment, the method 1400 may be performed at block 1010 (see FIG. 10).

Current payment source selections and associated priority retained within the payment source selections field 518 may be presented (e.g., to a user) at block 1402. For example, the current payment source selections may be a default payment source selection such as a balance having a first priority, a bank account having a second priority, and a credit card account having a third priority, or a previously user defined source selection.

A determination may be made at decision block 1404 whether a modification has been received to the payment source selections and the associated priority. If a determination is made that a modification has been received, the modification to the payment source selection and the associated priority may be recorded in the payment source selections field 518 at block 1406. If the modification has not been received at decision block 1404 or upon completion of the operations at block 1406, the method 1400 may proceed to decision block 1408.

At decision block 1408, a determination may be made as to whether there are further modifications to the payment source selections. If there are further modifications, method 1400 may return to block 1402. If there are no further modifications at decision block 1408, method 1400 may terminate.

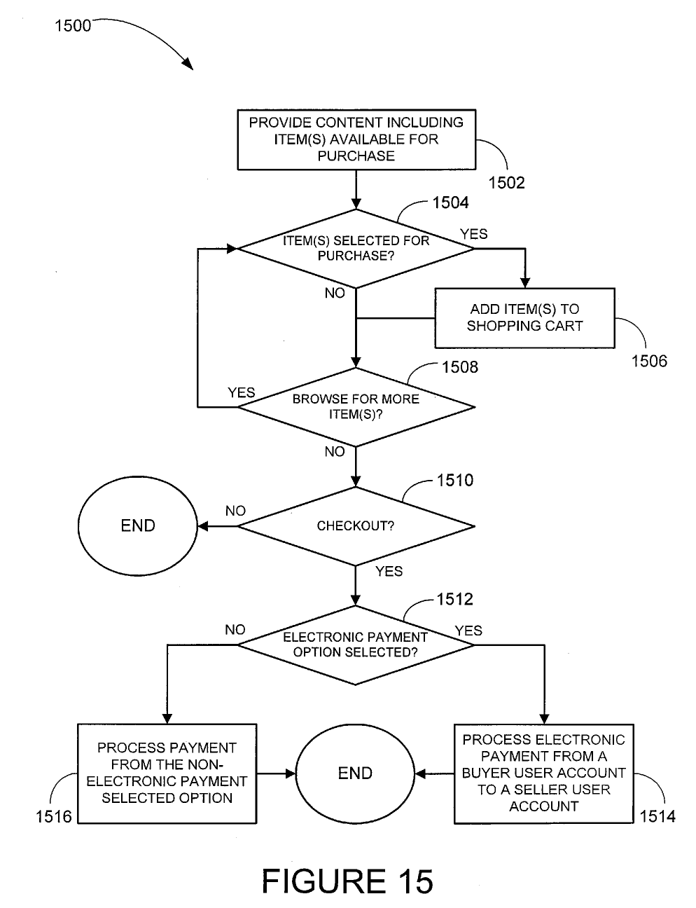

Referring to FIG. 15, a method 1500 for processing an order from the buyer machine 408 (see FIG. 4) according to an example embodiment is illustrated. In an example embodiment, the method 1500 may be performed at block 908 (see FIG. 9).

Content including items available for purchase may be provided at block 1502. For example, the content may be provided to the buyer machine 408 for presentation to a buyer.

A determination may be made at decision block 1504 whether one or more items were selected for purchase. For example, the items may be selected for purchase by a buyer through a web client 106 and/or a programmatic client 108 (see FIG. 1). If items were selected for purchase, the items may be added to a shopping cart at block 1506. If items were not selected for purchase at decision block 1504 upon completion of the operations at block 1506, the method 1500 may proceed to decision block 1508.

At decision block 1508, a determination may be made whether to browse for more items. If a determination is made to browse for more items, the method 1500 may return to decision block 1504. If a determination is made not to browse for more items at decision block 1508, the method 1500 may proceed to decision block 1510.

A determination may be made at decision block 1510 whether to check out. If a determination is made not to check out, the method 1500 may terminate. If the determination is made to check out, the method 1500 may proceed to decision block 1512.

A determination may be made at decision block 1512 as to whether an electronic payment option has been selected. For example, the electronic payment option may be selected from a number of payment options (e.g., check, credit card, gift card, and the like) by a user through a user interface available on the web client 106 and/or a programmatic client 108.

If an electronic payment option has been selected, the electronic payment may be processed from the user account of the buyer (e.g., a buyer user account) to the user account of the seller (e.g., a seller user account) at block 1514. An example embodiment of the processing the electronic payment is described in greater detail below. If the electronic payment option has not been selected at decision block 1512, the payment may be processed from a non-electronic payment option selected at block 1516. Upon completion of the operations at block 1514 or block 1516, the method 1500 may terminate.

In an example embodiment, the method 1500 may be modified so as to not use a shopping cart (e.g., to enable one-step checkout).

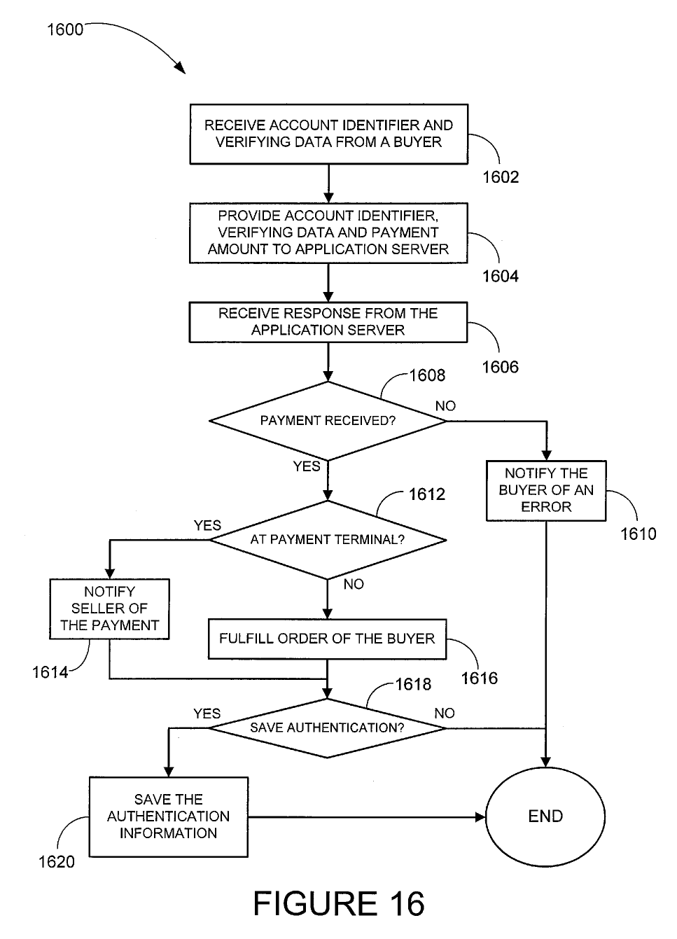

Referring to FIG. 16, a method 1600 for processing an electronic payment according to an example embodiment is illustrated. In an example embodiment, the method 1600 may be performed at block 912 (see FIG. 9), at block 1514 (see FIG. 15), on the seller server 406, and/or on the payment terminal 410 (see FIG. 4).

An account identifier 416 and a verifying data 420 may be received from a buyer at block 1602.

The account identifier 416, the verifying data 420, and a payment amount (e.g., an amount of value to be transferred from a buyer to the seller) may be provided to the payment server 402 (see FIG. 4) at block 1604.

A response (e.g., indicating whether the payment has been made) may be received from the payment server 402 at block 1606. For example a positive response may be provided for a user associated with the account identified when the verifying data 420 matches the matching selection 802 and the seller criterion 804 associated with the matching selection 802 is satisfied.

A determination may be made at decision block 1608 whether the payment has been received from the buyer (e.g., based on a positive response received at block 1606). If payment has not been received from the buyer, the buyer may be notified of an error at block 1610. If payment has been received from the buyer at decision block 1608, the method 1600 may proceed to decision block 1612.

At decision block 1612, a determination may be made as to whether the payment has been received from the payment terminal 410. If payment has been received from the payment terminal 410, the seller (e.g., through the seller server 402 or otherwise) may be notified of the payment at block 1614. If a determination is made that the payment has not been received from the payment terminal 410 at decision block 1612, the order of the buyer may be fulfilled (e.g., electronically fulfilled by the seller server 402) at block 1616. Upon completion of the operations at block 1616 or block 1614, the method 1600 may proceed to decision block 1618.

A determination may be made at decision block 1618 whether to save an authentication of the buyer. In an example embodiment, the authentication may be the account identifier 416 and the verifying data 420 provide by the user and/or an authentication token provided by the payment server 402. If the authentication is to be saved, the authentication information may be saved at block 1620. For example, the seller server 406 may associate the authentication information with a user name that is used by the buyer to make a transaction on the seller server 406. If the authentication information is not to be saved at decision block 1618 or upon completion of the operations at block 1620, the method 1600 may terminate.

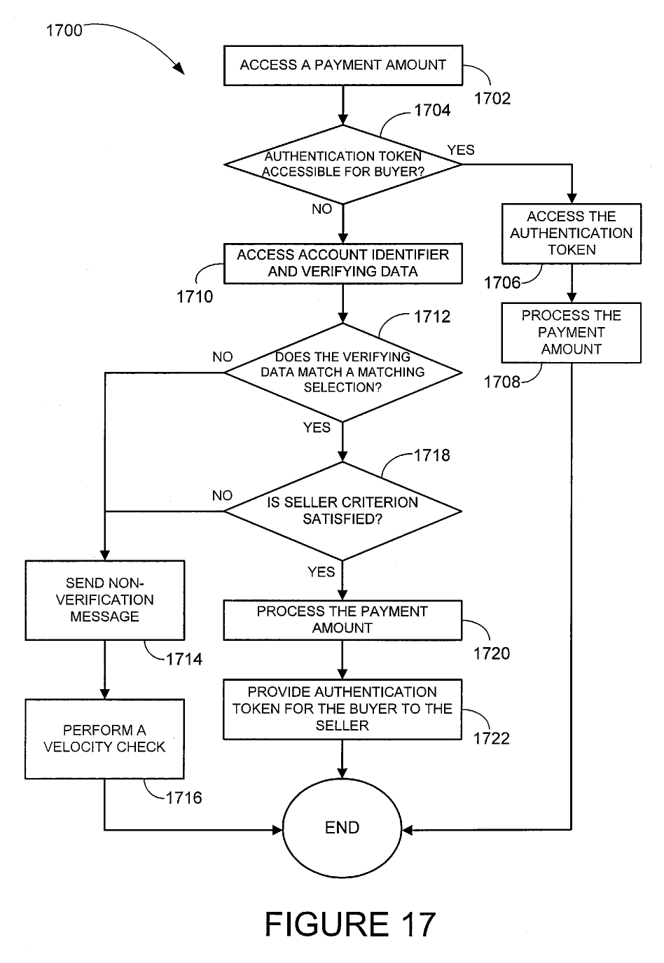

Referring to FIG. 17, a method 1700 for processing an electronic payment according to an example embodiment is illustrated. In an example embodiment, the method 1700 may be performed at block 912 (see FIG. 9), at block 1514 (see FIG. 15), and/or on the payment server 402 (see FIG. 4).

A payment amount may be accessed at block 1702. For example, the payment amount may be received during the operations at block 1604 (see FIG. 16).

A determination may be made at decision block 1704 whether an authentication token is accessible. In an example embodiment, the authentication token may be a unique identifier to provide authentication for future payments from a buyer to a seller without the need for re-authentication between the buyer, the seller and the payment server 402.

If the authentication token value is accessible, the authentication token may be accessed at block 1706 and the payment amount may be processed (e.g., the account value of the buyer may be decreased and a corresponding amount of the account value of the seller may be increased) at block 1708. If the authentication token value is not accessible at decision block 1704, the method 1700 may proceed to block 1710.

The account identifier 416 and the verifying data 420 may be accessed at block 1710. For example, the account identifier 416 and the verifying data 420 may be received during the operations at block 1604 (see FIG. 16). In an example embodiment, the account identifier 416 received during the operations at block 1710 may be used by the application to identify a matching selection 802 and an associated seller criterion 804 defined by the buyer.

A determination may be made at decision block 1712 as to whether the verifying data 420 matches a matching selection 802 of the payment transaction data structures 520. If the verifying data 420 does not match the matching selection 802, a non-verification message may be sent at block 1714. If the verifying data 420 matches the matching selection 802 at decision block 1712, the method 1700 may proceed to decision block 1718.

At decision block 1718, a determination may be made as to whether a seller criterion 804 of the matching selection 802 is satisfied (e.g., met). If the seller criterion 804 is not satisfied for the matching selection 802, a non-verification message may be sent at block 1714. If the seller criterion 804 is satisfied for the matching selection 802 at decision block 1718, the method 1700 may proceed to block 1720.

Upon completion of the operations at block 1714, the method 1700 may optionally perform a velocity check to see if a non-verification ceiling has been exceeded at block 1716. For example, the velocity check may be a check to determine whether a certain number of verification requests have been made from a same device (e.g., the client machine 110, 112 or the payment terminal 410) and/or for a same user that have been incorrect during a set amount of time. If the non-verification ceiling has been exceeded at block 1716, one or more preventive actions may be taken such as notifying the user of the attempt on the user's account, refusing all requests from the same device for a period of time, or the like.

The payment amount may be processed (e.g., the account value of the buyer may be decreased and a corresponding amount of the account value of the seller may be increased) at block 1720. For example, a positive response may be provided from the payment server 402 indicating that the payment amount has posted to the user account 422 of the seller. An example embodiment of processing the payment amount is described in greater detail below.

An authentication token may optionally be provided for the buyer to the seller at block 1722. Upon completion of the operations at block 1708, block 1714, block 1716, or block 1722, the method 1700 may terminate.

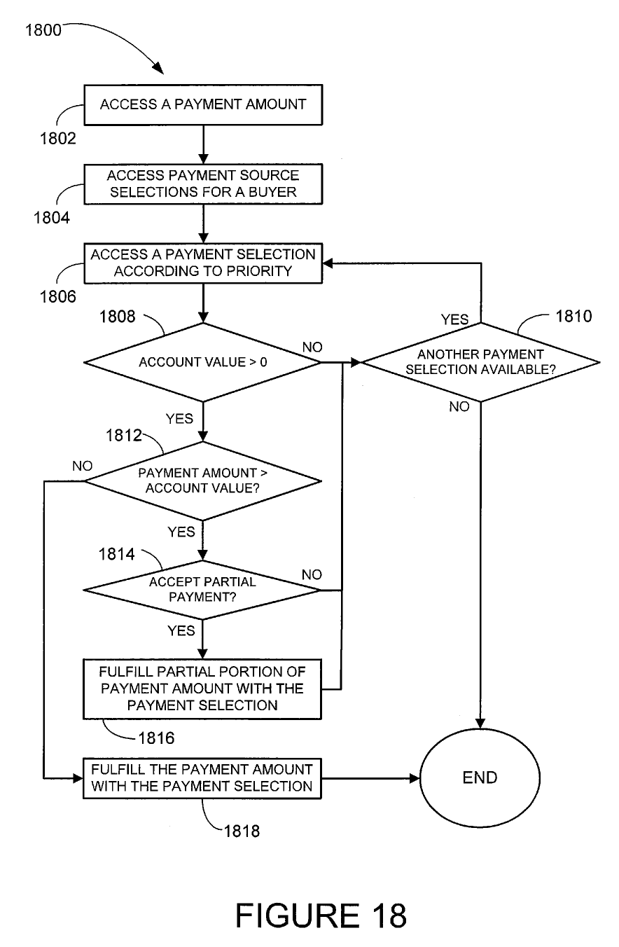

Referring to FIG. 18, a method 1800 for processing a payment amount according to example embodiment is illustrated. In an example embodiment, the method 1800 may be performed at block 1720 (see FIG. 17) and/or on the payment server 402 (see FIG. 4).

A payment amount may be accessed at block 1802. For example, the payment amount may be accessed during the operations at block 1702 (see FIG. 17).

Payment source selections and associated priority may be accessed from the payment source selections field 518 (see FIG. 5) for a buyer at block 1804.

A payment source selection may be accessed according to associated priority at block 1806. For example, the payment source selection with the highest priority may be first accessed, the payment source selection with the next highest priority may be accessed second, and so forth.

At decision block 1808, a determination may be made as to whether the account value of the payment selection is greater than zero. If the account value selection is not greater than zero, the method 1800 may proceed to decision block 1810 to determine whether another payment source selection is available. If another payment source selection is available at decision block 1810, the method 1800 may return to block 1806. If another payment source selection is not available at decision block 1810, the method 1800 may terminate.

If the account value of the payment source selection is greater than zero at decision block 1808, a determination may be made at decision block 1812 whether the payment amount is greater than the account value of the payment source selection.

If the payment amount is greater than the account value, a determination may be made at decision block 1814 whether to accept a partial payment. If a determination is made that the partial payment is not to be accepted, the method 1800 may proceed to decision block 1810. If a determination is made that the partial payment is to be accepted, a partial portion of the payment amount may be fulfilled with the account value of the payment source selection at block 1816 and the method 1800 may proceed to decision block 1810.

If the payment amount is not greater than the account value at decision block 1812, the payment amount may be fulfilled from the account value of the payment source selection at block 1818. Upon completion of the operations at block 1818, the method 1800 may terminate.

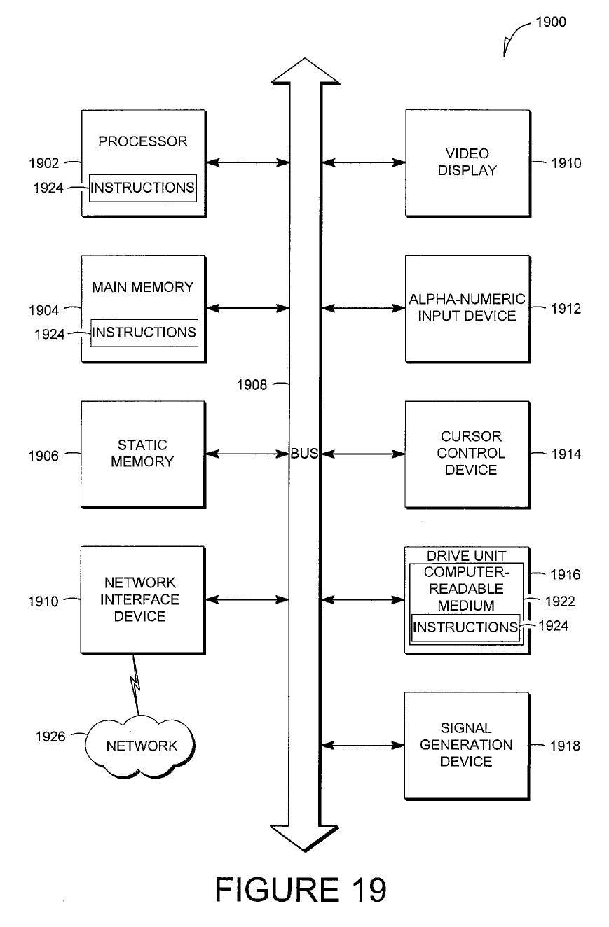

FIG. 19 shows a diagrammatic representation of machine in the example form of a computer system 1900 within which a set of instructions may be executed causing the machine to perform any one or more of the methodologies discussed herein. In alternative embodiments, the machine operates as a standalone device or may be connected (e.g., networked) to other machines. Tn a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU) a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alphanumeric input device 1912 (e.g., a keyboard), a cursor control device 1914 (e.g., a mouse), a drive unit 1916, a signal generation device 1918 (e.g., a speaker) and a network interface device 1910.

The drive unit 1916 includes a machine-readable medium 1922 on which is stored one or more sets of instructions (e.g., software 1924) embodying any one or more of the methodologies or functions described herein. The software 1924 may also reside, completely or at least partially, within the main memory 1904 and/or within the processor 1902 during execution thereof by the computer system 1900, the main memory 1904 and the processor 1902 also constituting machine-readable media.

The software 1924 may further be transmitted or received over a network 1926 via the network interface device 1910.

While the machine-readable medium 1922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for payment authentication have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
an electronic payment data structure comprising one or more electronic payment fields, each electronic payment field providing access to an account value from a payment source selected from at least one payment source;
a payment transaction data structure, the payment transaction data structure comprising a matching selection associated with a seller criterion, the matching selection to be compared against verifying data, the seller criterion defining a circumstance in which a payment request from a seller is to be fulfilled; and
a payment application to fulfill the payment request to the seller when the matching selection matches the verifying data and the circumstance defined by the seller criterion is met.

2. The system of claim 1, wherein the account value indicates a funds availability of the identified payment source in a commercial currency.

3. The system of claim 1, wherein the seller criterion is that the payment request is within a defined range.

4. The system of claim 1, wherein the matching selection is a pin number.

5. The system of claim 1, wherein the matching selection is a security question response, the security question response including a response to a security question.

6. The system of claim 1, wherein the electronic payment data field is at least one of:
a balance field for access to the account value of a user account,
a bank account field for access to the account value in a bank account, or
a credit card account field for access to the account value from a credit card account.

7. The system of claim 1, further comprising:
a payment source selection field to provide an identification of the one or more payment sources to be used for fulfilling a payment request and a priority order in which the one or more payment sources are to be used to fulfill the payment request.

8. The system of claim 1, further comprising at least one of:
an account type field to provide an account identifier to identify whether a user account is associated with a person or a business,
an account id field to provide an account id to enable identification of the user account,
an e-mail address field to provide an e-mail address of a user associated with the user account,
a personal/business information field to provide at least one of a name, a street address, a city, a state, a zip code, a phone number, a social security number, or an employee identification number,
a security question response field to provide a security question response,
a pin number field to provide a pin number for the user account, or
a user defined data field to provide user defined data.

9. A method comprising:
accessing a matching selection, the matching selection to be compared against verifying data;
associating at least one seller criterion with the matching selection, each of the at least one seller criterion defining a circumstance in which a payment request from a seller is to be fulfilled when the matching selection matches the verifying data; and
making the association of the at least one seller criterion with the matching selection available to a payment application, the payment application capable of using the association to determine whether to fulfill the payment request.

10. The method of claim 9, wherein a matching selection is selected from a group of matching selections consisting of at least one of:
an alternate e-mail address, personal information, business information, a security question response, a pin number, a portion of a credit card number, and user defined data.

11. The method of claim 9, wherein a seller criterion is selected from a group of seller criteria consisting of at least one of:
a dollar amount, a transaction history of a user, a geographic location, a seller tier, a seller identification, and a type of an item.

12. A method comprising:
accessing an account identifier and verifying data, the account identifier to identify a user account;
accessing one or more payment source selections associated with the user account; and
processing a payment amount from the one or more payment source selections when the verifying data matches a matching value and a seller criterion associated with the matching value is met.

13. The method of claim 12, wherein processing a payment amount from the one or more payment source selections comprises:
processing a payment amount from the one or more payment source selections based on an associated payment priority when the verifying data matches a matching value and a seller criterion associated with the matching value is met, the associated payment priority for each of the one or more payment source selections identifying an order in which the one or more payment source selections are to be selected for fulfilling the payment amount.

14. The method of claim 12, wherein the one or more payment source selections are selected from a group of payment sources consisting of at least one of:
a balance of a user account, funds available from a bank account, and funds available from a credit card.

15. The method of claim 12, further comprising:
selecting, as an authentication token, a unique identifier to provide authentication for future payments from a buyer to a seller without the need for re-authentication between the buyer, the seller and a payment server; and
providing the authentication token to the seller when the verifying data matches a matching value and a seller criterion associated with the matching value is met.

16. A method comprising:
providing an account identifier of a buyer, verifying data, and a payment amount to an application server, the payment amount including an amount of value to be transferred from the buyer to a seller, the account identifier to be used by the application server to identify a matching selection and an associated seller criterion defined by the buyer; and
receiving a positive response from the application server indicating that the payment amount has posted to an account of the seller when the verifying data matches the matching selection and the seller criterion is satisfied.

17. The method of claim 16, further comprising:
notifying the seller that the payment amount has posted to the account of the seller.

18. The method of claim 16, further comprising:
electronically fulfilling an order of the buyer upon receiving the positive response.

19. A machine-readable medium comprising instructions, which when executed by a machine, cause the machine to:
access a matching selection, the matching selection to be compared against verifying data;
associate at least one seller criterion with the matching selection, each of the at least one seller criterion defining a circumstance in which a payment request from a seller is to be fulfilled when the matching selection matches the verifying data; and
make the association of the at least one seller criterion with the matching selection available to a payment application, the payment application capable of using the association to determine whether to fulfill the payment request.

20. The machine-readable medium of claim 19, wherein a matching selection is selected from a group of matching selections consisting of at least one of:
an alternate e-mail address, personal information, business information, a security question response, a pin number, a portion of a credit card number, or user defined data.

21. A machine-readable medium comprising instructions, which when executed by a machine, cause the machine to:
access an account identifier and verifying data, the account identifier to identify a user account;
access one or more payment source selections associated with the user account; and
process a payment amount from the one or more payment source selections when the verifying data matches a matching value and a seller criterion associated with the matching value is met.

22. The machine-readable medium of claim 21, further comprising instructions, which when executed by a machine, cause the machine to:
select, as an authentication token, a unique identifier to provide authentication for future payments from a buyer to a seller without the need for re-authentication between the buyer, the seller and a payment server; and
provide the authentication token to the seller when the verifying data matches a matching value and a seller criterion associated with the matching value is met.

23. A machine-readable medium comprising instructions, which when executed by a machine, cause the machine to:
provide an account identifier of a buyer, verifying data, and a payment amount to an application server, the payment amount including an amount of value to be transferred from the buyer to a seller, the account identifier to be used by the application server to identify a matching selection and an associated seller criterion defined by the buyer; and
receive a positive response from the application server indicating that the payment amount has posted to an account of the seller when the verifying data matches the matching selection and the seller criterion is satisfied.

24. The machine-readable medium of claim 23, further comprising instructions, which when executed by a machine, cause the machine to:
electronically fulfill an order of the buyer upon receiving the positive response.
